(19) United States
(12) Patent Application Publication
(10) Pub. No.: US 2019/0246122 A1
(43) Pub. Date: Aug. 8, 2019

(54) PALETTE CODING FOR VIDEO CODING

(71) Applicant: QUALCOMM Incorporated, San Diego, CA (US)

(72) Inventors: Kai Zhang, San Diego, CA (US); Li Zhang, San Diego, CA (US); Wei-Jung Chien, San Diego, CA (US); Marta Karczewicz, San Diego, CA (US)

(21) Appl. No.: 16/268,894

(22) Filed: Feb. 6, 2019

Related U.S. Application Data
(60) Provisional application No. 62/628,006, filed on Feb. 8, 2018.

(51) Int. Cl. H04N 19/186; H04N 19/91; H04N 19/70; H04N 19/117; H04N 19/176

(52) U.S. Cl. CPC H04N 19/186; H04N 19/91; H04N 19/176; H04N 19/117; H04N 19/70

(57) ABSTRACT

A method of decoding video data including receiving a block of video data, determining to decode the block of video data using palette coding based on whether color components of the block of video data were partitioned according to a decoupled tree partition, and decoding the block of video data based on the determination.

This application claims the benefit of U.S. Provisional Application No. 62/628,006, filed Feb. 8, 2018, the entire content of which is incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for video encoding and decoding, including techniques for palette coding. The techniques of this disclosure may be used with any of the existing video codecs, such as ITU-T H.265 (also called HEVC (High Efficiency Video Coding)), and/or may be used with future video coding standards, such as ITU-T H.266 (also called Versatile Video Coding (VVC)).

In some examples, this disclosure describes techniques for determining whether or not a palette coding mode is enabled or disabled for blocks of video data that are partitioned using decoupled tree structures. In a decoupled tree structure, such as some quad-tree binary-tree partitioning structures of multi-type tree structures, luma and chroma blocks of video data may be partitioned independently. That is, luma blocks and chroma blocks in a picture do not need to be partitioned such that luma and chroma block boundaries are aligned. In addition, some example decoupled tree structures of this disclosure allow for one or more types of non-square blocks.

In one example, this disclosure describes a method of decoding video data, the method comprising receiving a block of video data, determining to decode the block of video data using palette coding based on whether color components of the block of video data were partitioned according to a decoupled tree partition, and decoding the block of video data based on the determination.

In another example, this disclosure describes an apparatus comprising a memory configured to store a block of video data, and one or more process in communication with the memory, the one or more processors configured to receive the block of video data, determine to decode the block of video data using palette coding based on whether color components of the block of video data were partitioned according to a decoupled tree partition, and decode the block of video data based on the determination.

In another example, this disclosure describes an apparatus comprising means for receiving a block of video data, means for determining to decode the block of video data using palette coding based on whether color components of the block of video data were partitioned according to a decoupled tree partition, and means for decoding the block of video data based on the determination.

In another example, this disclosure describes a non-transitory computer-readable storage medium storing instructions that, when executed, cause one or more processors configured to decode video data to receive the block of video data, determine to decode the block of video data using palette coding based on whether color components of the block of video data were partitioned according to a decoupled tree partition, and decode the block of video data based on the determination.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a conceptual diagram illustrating an example of palette coding.

FIG. 3A and FIG. 3B are conceptual diagrams illustrating an example quadtree partitioning structure and a corresponding coding tree unit (CTU).

FIG. 4A and FIG. 4B are conceptual diagrams illustrating an example quadtree binary tree (QTBT) partitioning structure and a corresponding CTU.

FIG. 5A and FIG. 5B are conceptual diagrams illustrating an example multi-type-tree (MTT) partitioning structure and a corresponding CTU.

FIG. 6 is a conceptual diagram illustrating another example of a CTU partitioned according to an MTT partitioning structure.

FIG. 7 is a block diagram illustrating an example video encoder that may perform the techniques of this disclosure.

FIG. 8 is a block diagram illustrating an example video decoder that may perform the techniques of this disclosure.

FIG. 9 is a conceptual diagram illustrating an example of palette coding for a luma component.

FIG. 10 is a conceptual diagram illustrating an example of palette coding for chroma components.

FIG. 11 is a conceptual diagram showing example scanning techniques for palette coding.

FIG. 12 is a conceptual diagram showing other example scanning techniques for palette coding.

FIG. 13 is a flowchart showing an example decoding method of the disclosure.

### DETAILED DESCRIPTION

In general, this disclosure describes techniques for video encoding and decoding, including techniques for palette coding. The techniques of this disclosure may be used with any of the existing video codecs, such as the HEVC standard (ITU-T H.265), or the next generation of video coding standards, such as Versatile Video Coding (VVC), or other standard or non-standard coding techniques.

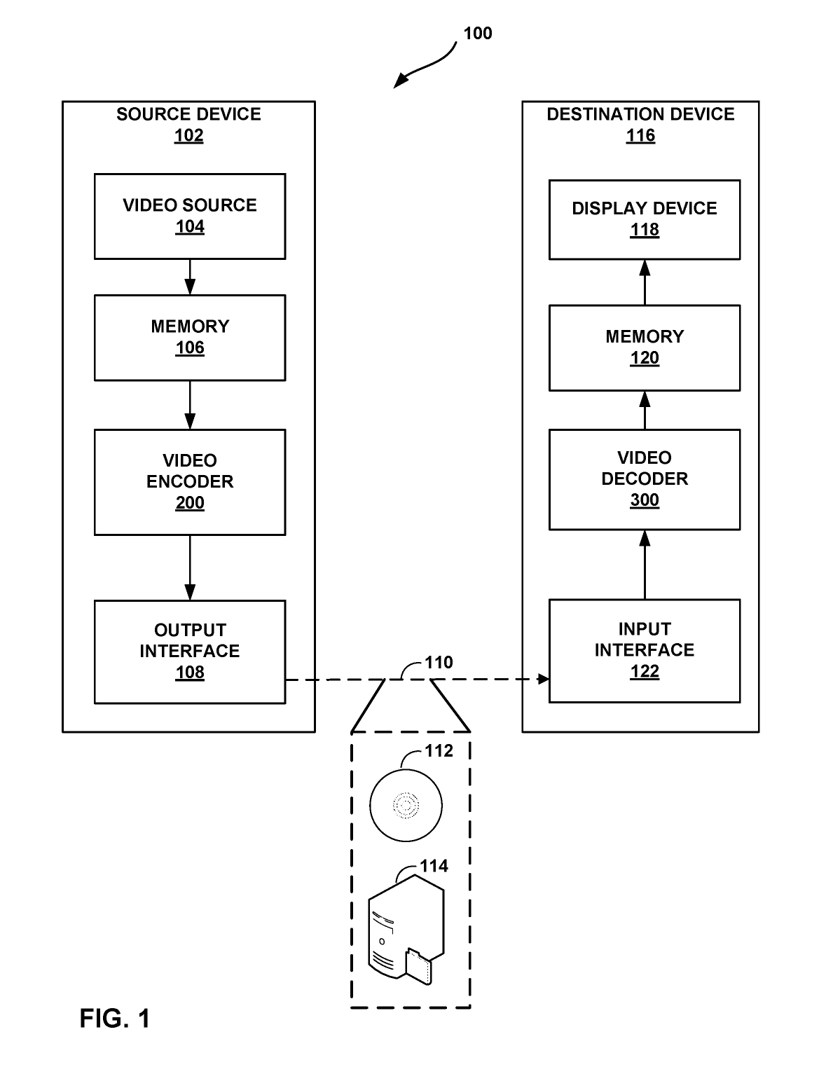

FIG. 1 is a block diagram illustrating an example video encoding and decoding system 100 that may perform the techniques of this disclosure for palette coding. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for palette coding. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for palette coding. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, devices 102, 116 may operate in a substantially symmetrical manner such that each of devices 102, 116 include video encoding and decoding components. Hence, system 100 may support one-way or two-way video transmission between video devices 102, 116, e.g., for video streaming, video playback, video broadcasting, or video telephony.

In general, video source 104 represents a source of video data (i.e., raw, uncoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some example, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video generated by source device 102. Destination device 116 may access stored video data from file server 114 via streaming or download. File server 114 may be any type of server device capable of storing encoded video data and transmitting that encoded video data to the destination device 116. File server 114 may represent a web server (e.g., for a website), a File Transfer Protocol (FTP) server, a content delivery network device, or a network attached storage (NAS) device. Destination device 116 may access encoded video data from file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on file server 114. File server 114 and input interface 122 may be configured to operate according to a streaming transmission protocol, a download transmission protocol, or a combination thereof.

Output interface 108 and input interface 122 may represent wireless transmitters/receiver, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., storage device 112, file server 114, or the like). The encoded video bitstream computer-readable medium 110 may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may comprise an integrated circuit, a microprocessor, and/or a wireless communication device, such as a cellular telephone.

Video encoder 200 and video decoder 300 may operate according to a video coding standard. Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In some examples, video encoder 200 and video decoder 300 may operate according to ITU-T H.265, also referred to as HEVC, including the HEVC range extension, multiview extension (MV-HEVC) and/or scalable extension (SHVC). HEVC was developed by the Joint Collaboration Team on Video Coding (JCT-VC) as well as the Joint Collaboration Team on 3D Video Coding Extension Development (JCT-3V) of ITU-T Video Coding Experts Group (VCEG) and ISO/IEC Motion Picture Experts Group (MPEG).

ITU-T VCEG (Q6/16) and ISO/IEC MPEG (JTC 1/SC 29/WG 11) are now studying the potential need for standardization of future video coding technology with a compression capability that exceeds that of the current HEVC standard (including its current extensions and near-term extensions for screen content coding and high-dynamic-range coding). The groups are working together on this exploration activity in a joint collaboration effort, known as the Joint Video Exploration Team (JVET), to evaluate compression technology designs proposed by their experts in this area. The JVET first met during 19-21 Oct. 2015. One version of the reference software, i.e., Joint Exploration Model 7 (JEM 7) may be downloaded from: https://jvet.hhi.fraunhofer.de/svn/svn_HMJEMSoftware/tags/HM-16.6-J EM-7.0/

An algorithm description of JEM 7 (J. Chen, et al. “Algorithm Description of Joint Exploration Test Model 7,” Joint Video Exploration Team (JVET) of ITU-T SG 16 WP 3 and ISO/IEC JTC 1/SC 29/WG 11, 7^{th} Meeting: Torino, IT, 13-21 Jul. 2017, “JVET-G1001 v1”) may be downloaded from http://phenix.it-sudparis.eu/jvet/doc end user/current document.php?id=3286.

An early draft for a new video coding standard, referred to as the H.266/Versatile Video Coding (VVC) standard, is available in the document JVET-J1001 “Versatile Video Coding (Draft 1)” by Benjamin Bross, and its algorithm description is available in the document JVET-J1002 “Algorithm description for Versatile Video Coding and Test Model 1 (VTM 1)” by Jianle Chen and Elena Alshina.

Video encoder 200 and video decoder 300 may operate according to other proprietary or industry standards, such as JEM 7 and future video coding standards being studied by the JVET, such as VVC. The techniques of this disclosure, however, are not limited to any particular coding standard.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

This disclosure may generally refer to “signaling” certain information, such as syntax elements. The term “signaling” may generally refer to the communication of values syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

HEVC defines various blocks, including coding units (CUs), prediction units (PUs), and transform units (TUs). In HEVC, the largest coding unit in a slice is called a coding tree unit (CTU). A CTU contains one luma coding tree block (CTB) and two chroma CTBs, the node of which are luma and chroma coding block (CB). One luma CB and ordinarily two chroma CBs, together with associated syntax, form a coding unit.

In some examples of the disclosure, video encoder 200 and video decoder 300 may be configured to code block of video data using a palette coding mode. Highly efficient screen content coding (SCC) has become a challenging topic. To address problems associated with SCC, JCTV-VC developed an SCC extension to HEVC. Palette coding is one of the coding tools used to code screen content in the SCC extension of HEVC.

In applications like remote desktop, collaborative work and wireless display, computer-generated screen content (e.g., such as text or computer graphics) may be the dominant content to be compressed. This type of content tends to have discrete-tone and feature sharp lines, and high contrast object boundaries. The assumption of continuous-tone and smoothness may no longer apply for screen content, and thus traditional video coding techniques may not be efficient ways to compress video data including screen content.

In general, palette coding is designed to handle the clustering of colors in screen content. Palette coding employs base colors and an index map to represent the input image block. Video encoder 200 may quantize samples to one of the base colors in the input block and an index map may be generated to indicate the corresponding base color for each sample. Due to the sparse histogram of screen contents, the coding cost is significantly reduced by a small number of colors in each block.

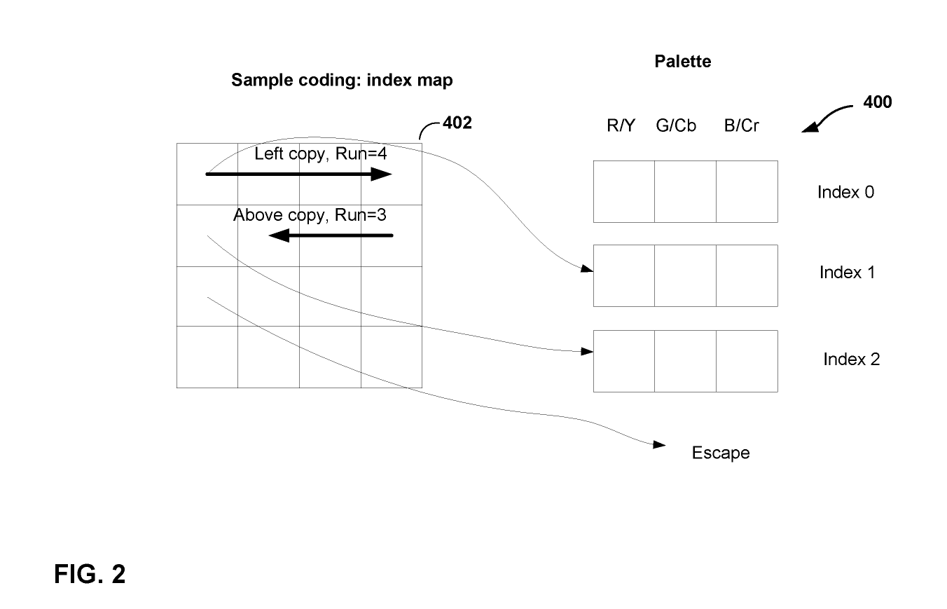

As demonstrated in FIG. 2, video encoder 200 and video decoder 300 may code a table 400 named ‘Palette’ for a CU 402 to indicate the base colors which may appear in current CU 402. Table 400 may include color entries, each of which are represented by an index. In FIG. 2, table 400 may include color entries in any color format, e.g., RGB, YCbCr, or another color format. Video encoder 200 and video decoder 300 may code the palette using predictive techniques to save bits. After that, video encoder 200 and video decoder 300 may code the samples (e.g., the luma and chroma color components of a pixel) in current CU 402. Video encoder 200 may quantize a sample to one of the base colors in the palette. Then, video encoder 200 may code the index corresponding to that base color. To code indices for all the samples more efficiently, video encoder 200 may put the indices together as an index map and code the index map as a whole. Video encoder 200 and video decoder 300 may be configured to scan the samples in the index map horizontally or vertically in a rotated way.

Video encoder 200 may be configured to determine to apply an INDEX mode to signal the index for a particular sample. Video encoder 200 may also determine to use a COPY_ABOVE mode. In a COPY_ABOVE mode, the index for a sample is copied from the index of its above neighboring sample. Video encoder 200 may signal a bit to indicate which mode is used for a particular sample. To further reduce bits, several consecutive samples may share the same mode. Video encoder 200 may code a run length to represent how many consecutive samples share the same mode. If the current sample utilizes INDEX mode, then a number of consecutive samples indicated by the run length will share the same index as the current sample. If the current sample utilizes COPY_ABOVE, a number of consecutive samples indicated by the run length will share the COPY_ABOVE mode, i.e., video decoder 300 will copy the indices from their above neighboring samples for these samples. In addition, a sample can also be coded directly (i.e., video encoder 200 may directly encode a sample value) in an ESCAPE mode to handle outlier cases (e.g., sample values not in the palette).

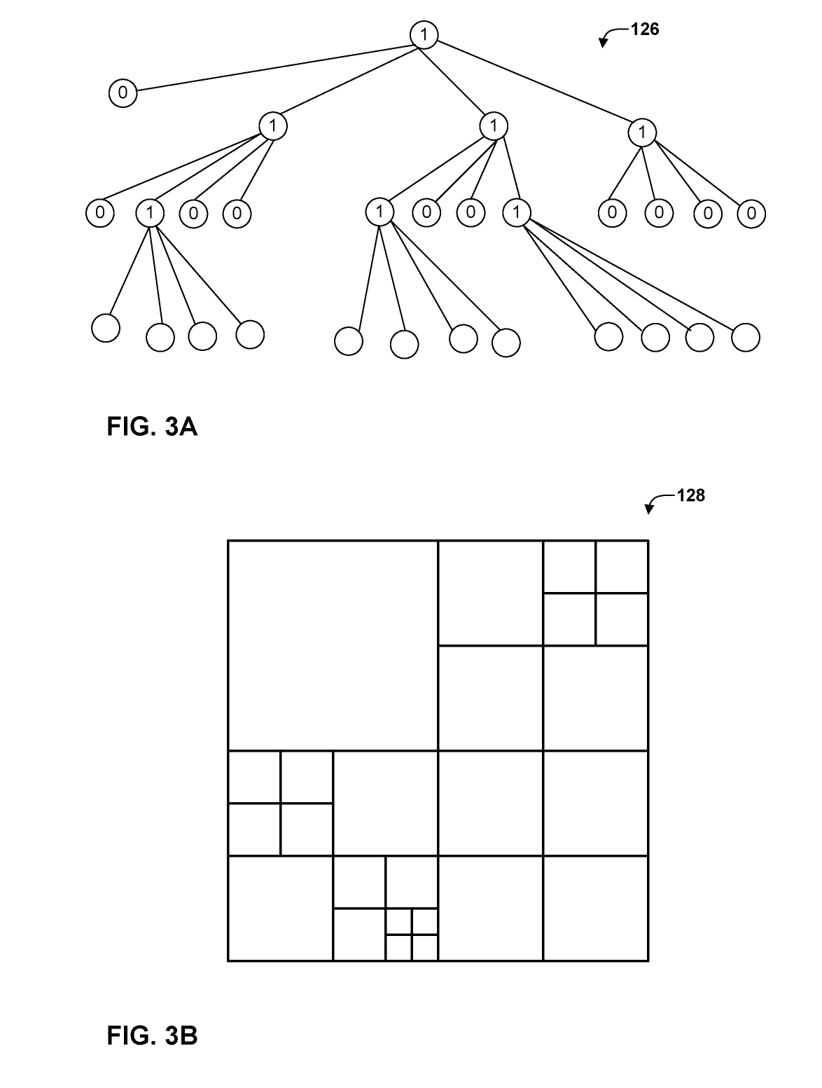

Example palette coding techniques have been used for blocks partitioned according to a quadtree partitioning structure. When operating according to HEVC, video encoder 200 may recursively split a CTU into CUs in a quadtree manner, such as shown in FIG. 3A and FIG. 3B. FIG. 3A and FIG. 3B are conceptual diagrams illustrating an example quadtree partitioning structure 126 and a corresponding CTU 128. In each split (i.e., non-leaf) node of the binary tree structure 126 (also called a splitting tree), one flag (e.g., a split flag) is signaled to indicate whether or not a block at the node is split into four equal-sized blocks, where 0 indicates a block at the node is not split and 1 indicates that the block at the node is split. In the following context, every tree node of the CU splitting tree is termed as a CU splitting node.

The size of a luma CTB can range from 16×16 to 64×64 in the HEVC main profile (although technically 8×8 CTB sizes can be supported). A CU could be the same size of a CTB although it can be as small as 8×8. Each coding unit, i.e., leaf node in the coding tree, is coded with one mode which could be either intra mode or inter mode.

Video encoder 200 may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

Block partitioning structures beyond HEVC and their signalling will now be discussed. In VCEG proposal COM16-C966 (J. An, Y.-W. Chen, K. Zhang, H. Huang, Y.-W. Huang, and S. Lei., “Block partitioning structure for next generation video coding,” International Telecommunication Union, COM16-C966, September 2015), a quadtree-binary-tree (QTBT) partitioning structure was proposed for future video coding standards beyond HEVC, such as VVC. Simulations showed that the proposed QTBT structure is more efficient than the quadtree structure used in HEVC.

In the proposed QTBT structure, video encoder 200 first partitions a CTB with a quadtree structure, where the quadtree splitting of one node can be iterated until the node reaches the minimum allowed quadtree leaf node size (MinQTSize). If the quadtree leaf node size is not larger than the maximum allowed binary tree root node size (MaxBTSize), the node can be further partitioned by a binary tree. In binary tree splitting, a block is split into two blocks, either horizontally or vertically. In this example, there are two splitting types: symmetric horizontal splitting and symmetric vertical splitting. The binary tree splitting of one node can be iterated until the node reaches the minimum allowed binary tree leaf node size (MinBTSize) or the maximum allowed binary tree depth (MaxBTDepth). In this example, the binary tree leaf node is the CU, which will be used for prediction (e.g. intra-picture or inter-picture prediction) and transform without any further partitioning.

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. Video encoder 200 applies quadtree partitioning to the CTU first to generate quadtree leaf nodes. The quadtree leaf nodes may have a size from 16×16 (i.e., the MinQTSize) to 128×128 (i.e., the CTU size). If the leaf quadtree node is 128×128, it will not be further split by the binary tree since the size exceeds the MaxBTSize (i.e., 64×64). Otherwise, the leaf quadtree node will be further partitioned by the binary tree. Therefore, the quadtree leaf node is also the root node for the binary tree and has the binary tree depth as 0. When the binary tree depth reaches MaxBTDepth (i.e., 4), it implies that there is no further splitting. When the binary tree node has width equal to MinBTSize (i.e., 4), it implies that there is no further horizontal splitting. Similarly, when the binary tree node has height equal to MinBTSize, it implies that there is no further vertical splitting. The leaf nodes of the binary tree (namely the CUs) are further processed by prediction and transform without any further partitioning.

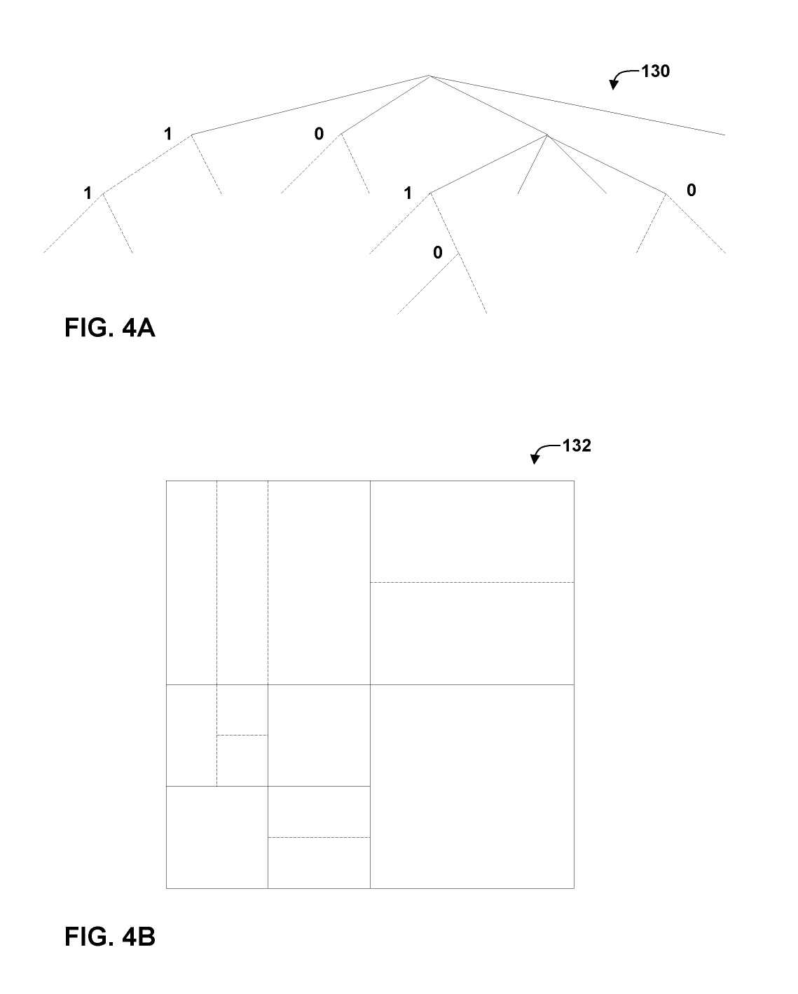

FIG. 4A and FIG. 4B are conceptual diagrams illustrating an example QTBT partitioning structure 130 and a corresponding CTU 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In some examples, a QTBT partitioning structure may have a decoupled tree structure. For example, a QTBT block structure may have the feature that luma and chroma blocks may have separate QTBT structures (e.g., the partitioning of luma blocks and chroma blocks are decoupled and partitioning is performed independently). In some examples, for P and B slices, the luma and chroma CTUs in one CTU share the same QTBT structure. For I slices, the luma CTU may be partitioned into CUs by a QTBT structure, and chroma CTUs may be partitioned into chroma CUs using another, different QTBT structure. This means that a CU in an I slice may include a coding block of luma component or coding blocks of two chroma component, and a CU in P and B slices may include coding blocks of all three color components.

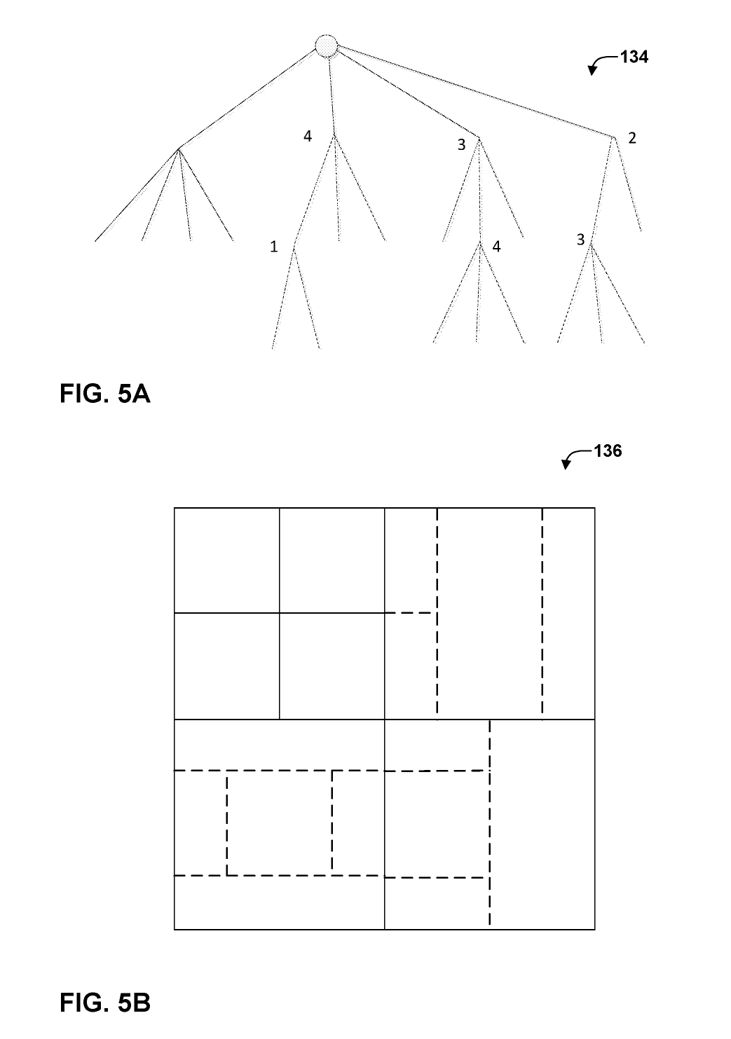

A multi-type-tree (MTT) partitioning structure will now be described. In U.S. Patent Publication No. 2017/0208336, published Jul. 20, 2017, and U.S. Patent Publication No. 2017/0272782, published Sep. 21, 2017, example MTT partition structures are described. According to example MTT partitions structures, video encoder 200 may be configured to further split a tree node with multiple tree types, such as binary tree, symmetric center-side triple tree, and quadtree. In the two-level MTT structure, a Region Tree (RT) is constructed first with quadtree partitions of a CTU, followed by the construction of a Prediction Tree (PT), where only binary tree and the symmetric center-side triple tree can be expanded. FIG. 5A and FIG. 5B are conceptual diagrams illustrating an example MTT partitioning structure 134 and a corresponding CTU 136.

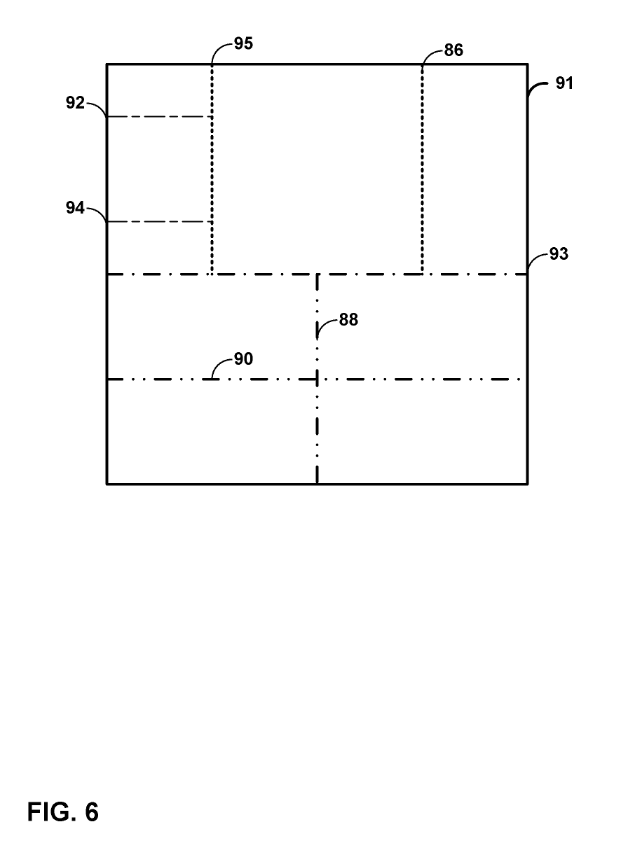

FIG. 6 is a conceptual diagram illustrating another example of a CTU partitioned according to an MTT partitioning structure. In other words, FIG. 6 illustrates the partitioning of a CTB 91 corresponding to a CTU. In the example of FIG. 6:
At depth 0, CTB 91 (i.e., the whole CTB) is split into two blocks with horizontal binary-tree partitioning (as indicated by line 93 with dashes separated by single dots).
At depth 1:
   The upper block is split into three blocks with vertical center-side triple-tree partitioning (as indicated by lines 95 and 86 with small dashes).
   The bottom block is split into four blocks with quad-tree partitioning (as indicated by lines 88 and 90 with dashes separated by two dots).
At depth 2:
   The left side block of the upper block at depth 1 is split into three blocks with horizontal center-side triple-tree partitioning (as indicated by lines 92 and 94 with long dashes separated by short dashes).
   No further split for the center and right blocks of the upper block at depth 1.
   No further split for the four blocks of the bottom block at depth 1.

As can be seen in the example of FIG. 6, three different partition structures are used (BT, QT, and TT) with four different partition types (horizontal binary-tree partitioning, vertical center-side triple-tree partitioning, quadtree partitioning, and horizontal center-side triple-tree partitioning).

Compared to the CU structure in HEVC and the QTBT structure, an MTT partitioning structure provides better coding efficiency as the block partitions are more flexible. In addition, the introduction of the center-side triple tree partitions provides more flexible localization of video signals. In the MTT partitioning structure, three bins are used to determine the block partition at each PT node (except for conditions where some constraints can be imposed, such as described in U.S. Patent Publication No. 2017/0272782) to represent block partitions of non-split, horizontal binary tree, vertical binary tree, horizontal triple tree, and vertical triple tree partitions. Due to the newly introduced triple partitions (triple-tree (TT) partitions), the number of bits used to signal the tree types will be increased from HEVC.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT or MTT structure for the luminance component and another QTBT or MTT structure for both chrominance components (or two QTBT or MTT structures for respective chrominance components).

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Examples of JEM and VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. One example of JEM and VVC provides sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the coefficients, providing further compression. By performing the quantization process, video encoder 200 may reduce the bit depth associated with some or all of the coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information of a picture into CTUs, and partitioning of each CTU according to a corresponding partition structure, such as a QTBT or MTT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

As will be described in more detail below, in accordance with the techniques of this disclosure, video encoder 200 and video decoder 300 may be configured to determine whether or not to code a block of video data using palette coding based on whether or not color components of the block of video data were partitioned according to a decoupled tree partition, and code the block of video data based on the determination. Video encoder 200 and video decoder 300 may also be configured to receive a block of video data having a non-square shape, and code the block of video data using palette coding according to a scan order based on the non-square shape. Video encoder 200 and video decoder 300 may also be configured to disable bilateral filtering or adaptive loop filtering for a block of video data coded using palette coding.

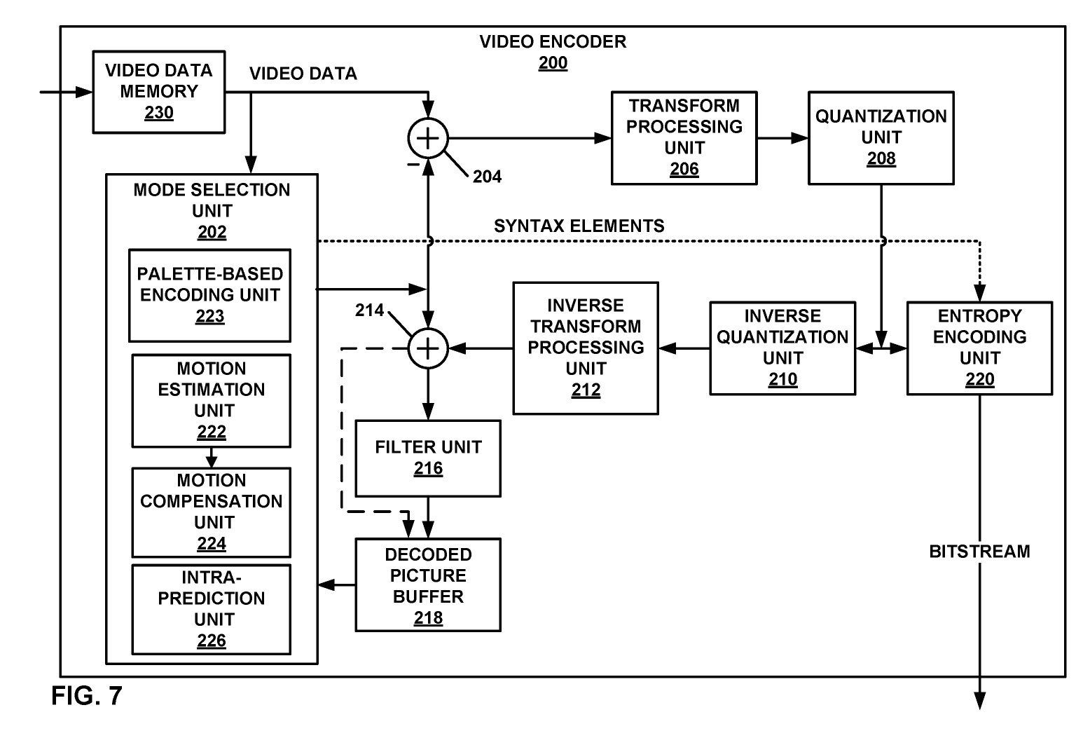

FIG. 7 is a block diagram illustrating an example video encoder 200 that may perform the techniques of this disclosure described above. FIG. 7 is provided for purposes of explanation and should not be considered limiting of the techniques as broadly exemplified and described in this disclosure. For purposes of explanation, this disclosure describes video encoder 200 in the context of video coding standards such as the HEVC video coding standard and the H.266 video coding standard in development (e.g., VVC). However, the techniques of this disclosure are not limited to these video coding standards and are applicable generally to video encoding and decoding.

In the example of FIG. 7, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Video encoder 200 also includes palette-based encoding unit 223 configured to perform various aspects of the palette-based coding techniques described in this disclosure.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random-access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 7 are illustrated to assist with understanding the operations performed by video encoder 200. The units may be implemented as fixed-function circuits, programmable circuits, or a combination thereof. Fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the object code of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, motion compensation unit 224, and an intra-prediction unit 226. Mode selection unit 202 may include additional functional units to perform video prediction in accordance with other prediction modes. As examples, mode selection unit 202 may include a palette-based encoding unit 223, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs and encapsulate one or more CTUs within a slice. Mode selection unit 202 may partition a CTU of the picture in accordance with a tree structure, such as the QTBT structure, the quad-tree structure of HEVC, or the MTT structure described above. As described above, video encoder 200 may form one or more CUs from partitioning a CTU according to the tree structure. Such a CU may also be referred to generally as a “video block” or “block.”

In general, mode selection unit 202 also controls the components of mode selection unit 202 (e.g., palette-based encoding unit 223, motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

Mode selection unit 202 provides the prediction block to residual generation unit 204. Residual generation unit 204 receives a raw, uncoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, affine-mode coding, and linear model (LM) mode coding, as few examples, mode selection unit 202, via respective units associated with the coding techniques, generates a prediction block for the current block being encoded. In some examples, such as palette mode coding, mode selection unit 202 may not generate a prediction block, and instead generates syntax elements that indicate the manner in which to reconstruct the block based on a selected palette. In such modes, mode selection unit 202 may provide these syntax elements to entropy encoding unit 220 to be encoded.

Palette-based encoding unit 223 may be configured to encode a block of video data (e.g., a CU or PU) with a palette-based encoding mode. In a palette-based encoding mode, a palette may include entries numbered by an index and representing color component values (for example, RGB, YUV etc.) or intensities which may be used to indicate pixel values. Palette-based encoding unit 223 may be configured to perform any combination of the techniques described in this disclosure related to palette coding.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks, including adaptive loop filtering (ALF) and bilateral filtering. In another example, filter unit 216 may perform deblocking operations to reduce blockiness artifacts along edges of CUs. As illustrated by dashed lines, operations of filter unit 216 may be skipped in some examples.

Video encoder 200 stores reconstructed blocks in DPB 218. For instance, in examples where operations of filter unit 216 are not needed, reconstruction unit 214 may store reconstructed blocks to DPB 218. In examples where operations of filter unit 216 are needed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded. Video encoder 200 may output a bitstream that includes the entropy encoded syntax elements needed to reconstruct blocks of a slice or picture.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

As will be described in more detail below, in accordance with the techniques of this disclosure, video encoder 200 may be configured to determine whether or not to code a block of video data using palette coding based on whether or not color components of the block of video data were partitioned according to a decoupled tree partition, and code the block of video data based on the determination. Video encoder 200 may also be configured to receive a block of video data having a non-square shape, and code the block of video data using palette coding according to a scan order based on the non-square shape. Video encoder 200 may also be configured to disable bilateral filtering or adaptive loop filtering for a block of video data coded using palette coding.

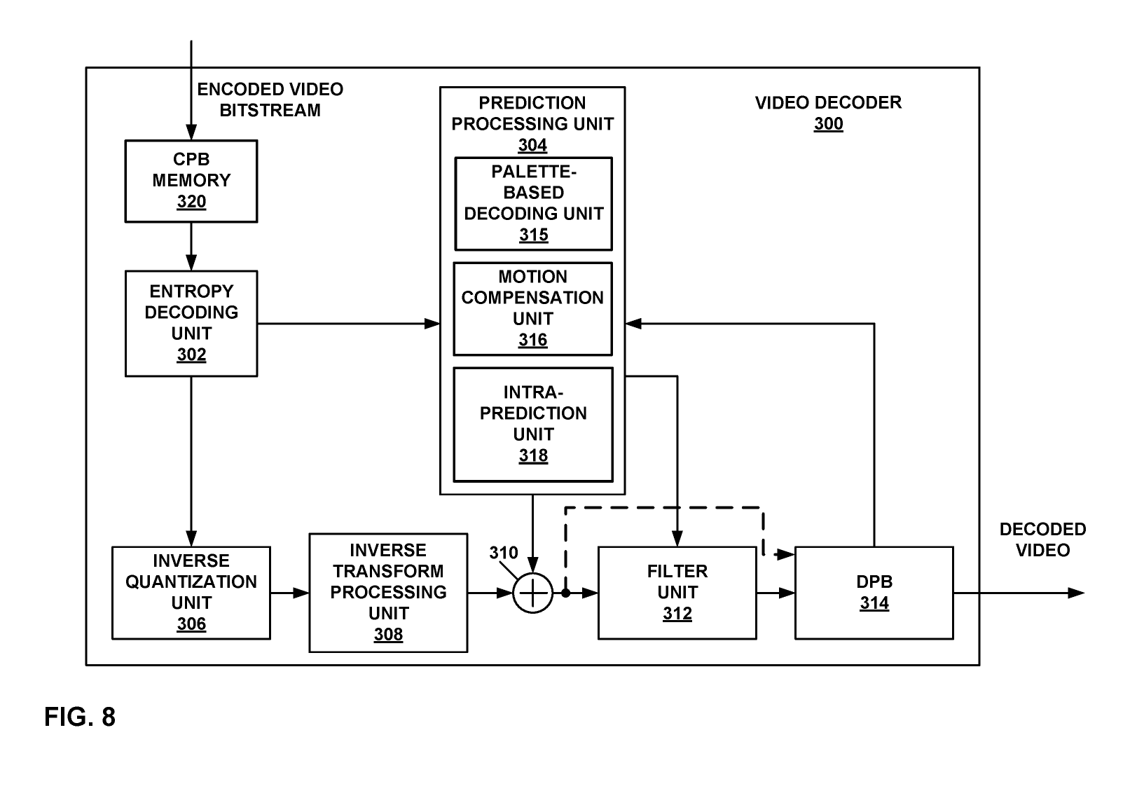

FIG. 8 is a block diagram illustrating an example video decoder 300 that may perform the techniques of this disclosure. FIG. 8 is provided for purposes of explanation and is not limiting on the techniques as broadly exemplified and described in this disclosure. For purposes of explanation, this disclosure describes video decoder 300 is described according to the techniques of VVC, JEM, and HEVC. However, the techniques of this disclosure may be performed by video coding devices that are configured to other video coding standards.

In the example of FIG. 8, video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Prediction processing unit 304 includes motion compensation unit 316 and intra-prediction unit 318. Prediction processing unit 304 may include additional units to perform prediction in accordance with other prediction modes. As examples, prediction processing unit 304 may include a palette-based decoding unit 315, an intra-block copy unit (which may form part of motion compensation unit 316), an affine unit, a linear model (LM) unit, or the like. In other examples, video decoder 300 may include more, fewer, or different functional components. Palette-based decoding unit 315 may be configured to perform various aspects of the palette-based coding techniques described in this disclosure. Palette-based decoding unit 315 may be configured to perform in a reciprocal manner to palette-based encoding unit 223 of FIG. 7.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as dynamic random-access memory (DRAM), including synchronous DRAM (SDRAM), magnetoresistive RAM (MRAM), resistive RAM (RRAM), or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to executed by processing circuitry of video decoder 300.

The various units shown in FIG. 8 are illustrated to assist with understanding the operations performed by video decoder 300. The units may be implemented as fixed-function circuits, programmable circuits, or a combination thereof. Similar to FIG. 7, fixed-function circuits refer to circuits that provide particular functionality and are preset on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”). CTUs of a picture may be partitioned in accordance with a tree structure, such as the QTBT structure, the quad-tree structure of HEVC, or the MTT structure described above.

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 7).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 7). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks, including adaptive loop filtering (ALF) and bilateral filtering. In another example, filter unit 312 may perform deblocking operations to reduce blockiness artifacts along edges of the reconstructed blocks. As illustrated by dashed lines, operations of filter unit 312 are not necessarily performed in all examples.

Video decoder 300 may store the reconstructed blocks in DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures from DPB for subsequent presentation on a display device, such as display device 118 of FIG. 1.

As will be described in more detail below, in accordance with the techniques of this disclosure, video decoder 300 may be configured to determine whether or not to code a block of video data using palette coding based on whether or not color components of the block of video data were partitioned according to a decoupled tree partition, and code the block of video data based on the determination. Video decoder 300 may also be configured to receive a block of video data having a non-square shape, and code the block of video data using palette coding according to a scan order based on the non-square shape. Video decoder 3000 may also be configured to disable bilateral filtering or adaptive loop filtering for a block of video data coded using palette coding.

Due to immersive new coding tools in JEM and VVC, including the potential use of QTBT or MTT partitioning with or without decoupled tree structures, several problems related to palette coding have been identified. For example, some example palette coding techniques code the samples of all components in a CU together (i.e., all color components (RGB, YCrCb, YUV, etc.) are coded with one palette index). Techniques for performing palette coding using decoupled partition trees have not been specified. Also, example palette coding techniques scan a palette index inside a block supposing that the block is square. Previous example scanning techniques may be inefficient for non-square blocks, such as those that may be used in QTBT or MTT partitioning.

In one example of the disclosure, when the partition trees are decoupled for different color components (e.g., different partition structures for luma and chroma components), video encoder 200 and video decoder 300 may be configured to perform palette coding differently from the case when different color components share the same partitioning tree. Decoupled partition trees may result in luma blocks being differently sized than corresponding chroma blocks. As such, luma blocks and chroma blocks may be unaligned (e.g., may overlap).

In one example of the disclosure, video encoder 200 may generate and signal a flag in a syntax structure to indicate whether palette mode is enabled when the partition trees are decoupled. Video decoder 300 may perform or not perform palette coding for certain luma and/or chroma blocks based on the value of the flag. Example syntax structures may include a sequence parameter set (SPS), a video parameter set (VPS), a picture parameter set (PPS), and/or a slice header.

In another example of the disclosure, video encoder 200 and video decoder 300 are configured to not use palette coding (e.g., palette coding is not allowed) in a picture or slice or CTU where partition trees are decoupled for different color components. In this case, the flag indicating whether to apply palette coding for a block described above is not signaled. That is, video encoder 200 and video decoder 300 may be preconfigured to disable palette coding for any picture, slice, or CTU where partition trees for luma and chroma components are decoupled.

In another example of the disclosure, video encoder 200 and video decoder 300 are configured to use palette coding (e.g., palette coding is allowed) for specific color component(s) if partition trees are decoupled for different color components. For example, video encoder 200 and video decoder 300 may be configured to use palette coding (i.e., palette coding is allowed) when coding luma blocks. However, video encoder 200 and video decoder 300 may be configured to not use (e.g., disable) palette coding for chroma blocks. In this example, video encoder 200 may generate a flag to indicate whether palette coding is used when coding a CU of luma component. Video decoder 300 may be configured to receive and decode such a flag and apply palette coding accordingly. Video encoder 200 may not signal a flag to indicate whether palette coding is used when coding a CU of chroma components. In this case, video decoder 300 may be configured to always disallow use of palette coding for chroma blocks.

In another example of the disclosure, video encoder 200 and video decoder 300 may be configured to use palette coding (e.g., palette coding is allowed) on all color components if partition trees are decoupled for different color components. For example, video encoder 200 and video decoder 300 may be configured to use palette coding for luma component coding based on a flag signaled to indicate whether palette coding is used when coding a CU of luma component. In addition, video encoder 200 and video decoder 300 may be configured to use palette coding for chroma components coding based on another flag signaled to indicate whether palette coding is used when coding a CU of chroma components. In this example, separate flags are used for different color components to enable or disable palette coding.

In another example of the disclosure, video encoder 200 and video decoder may be configured to code a flag whose value indicates whether palette coding is used for a block of later coded component(s) based on the coding of a flag indicating whether palette coding is used for a corresponding block of previously-coded component(s). For example, the coding of the palette coding flag for a block (named current block) of the Cb and Cr components can depend on the coding of the palette coding flag for a corresponding block of the Y component coded before Cb and Cr components. This corresponding block can be any block inside/outside or overlapped with the current block. For example, the corresponding block is the center 4×4 block inside the current block.

In another example of the disclosure, video encoder 200 does not perform additional signaling of palette mode flags for later coded components (e.g., Cb and/or Cr components after other chroma or luma components have been coded). Instead, video decoder 300 may be configured to derive the value of the palette mode flags from a signaled mode index. For example, video decoder 300 may first decode a luma block and then may decode chroma blocks. Therefore, for a chroma block, if the coding mode is set to direct mode (DM) and the luma block corresponding to the chroma block is coded as palette mode, in this case, video decoder 300 may be configured to decode the current chroma block with palette mode.

In another example of the disclosure, for palette coding applied on specific color component(s) (e.g., luma or chroma components), video encoder 200 and video decoder 300 may be configured to generate a palette that addresses sample values of specific color component(s) only. That is, video encoder 200 and video decoder 300 may be configured to generate a separate palette for each block of a color component that is coded using palette mode. In the reconstruction step (e.g., when particular color component sample values are coded), only the sample values of the specific color component(s) are reconstructed from the palette indices.

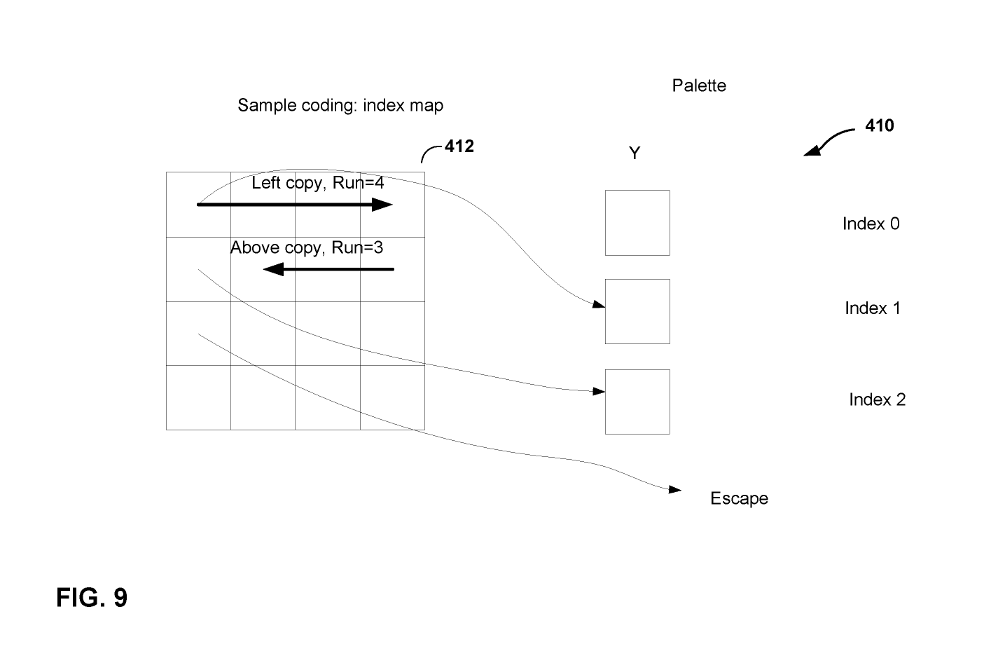

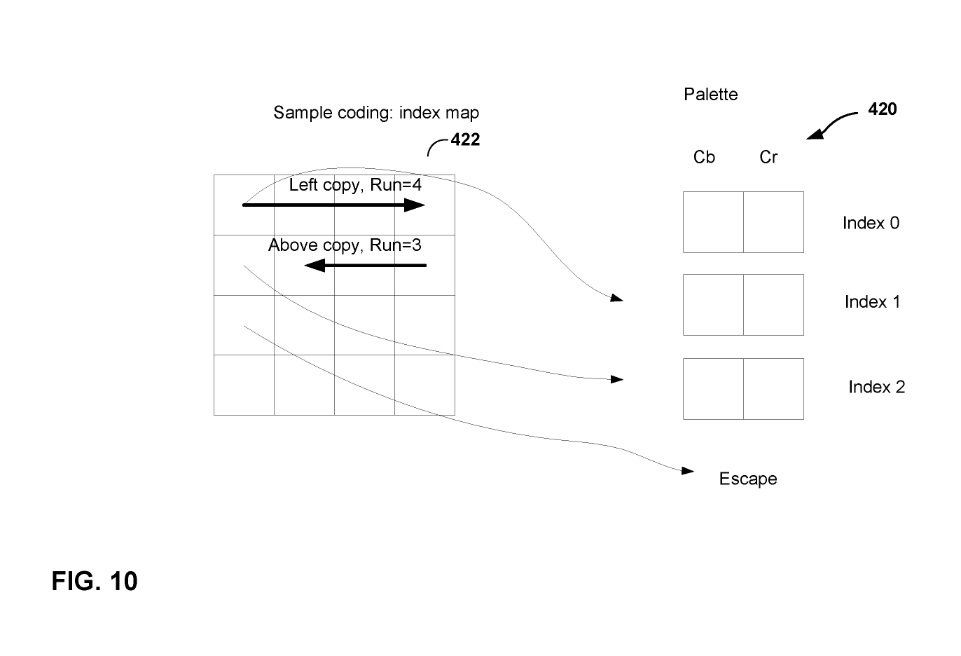

FIG. 9 and FIG. 10 illustrate two examples of palette coding for component Y and for component Cb and Cr, respectively. Video encoder 200 and video decoder 300 may configured to perform palette mode coding in the same manner discussed above with reference to FIG. 2. However, rather than having a single palette table 400 having color entries for all color components, as shown in FIG. 2, in this example of the disclosure, video encoder 200 and video decoder 300 may be configured to generate and use separate palette tables for different color components. As shown in FIG. 9, for luma blocks (e.g., blocks having only luma sample values), video encoder 200 and video decoder 300 may generate and use palette table 410 with only luma (Y) color entries when coding luma block 412. Similarly, as shown in FIG. 10, for chroma blocks (e.g., blocks having only Cr or Cb sample values), video encoder 200 and video decoder 300 may generate and use palette table 420 with only chroma (Cr and Cb) color entries when coding chroma block 422. In some examples, video encoder 200 and video decoder 300 may also generate and use separate palette tables for each of the chroma components.

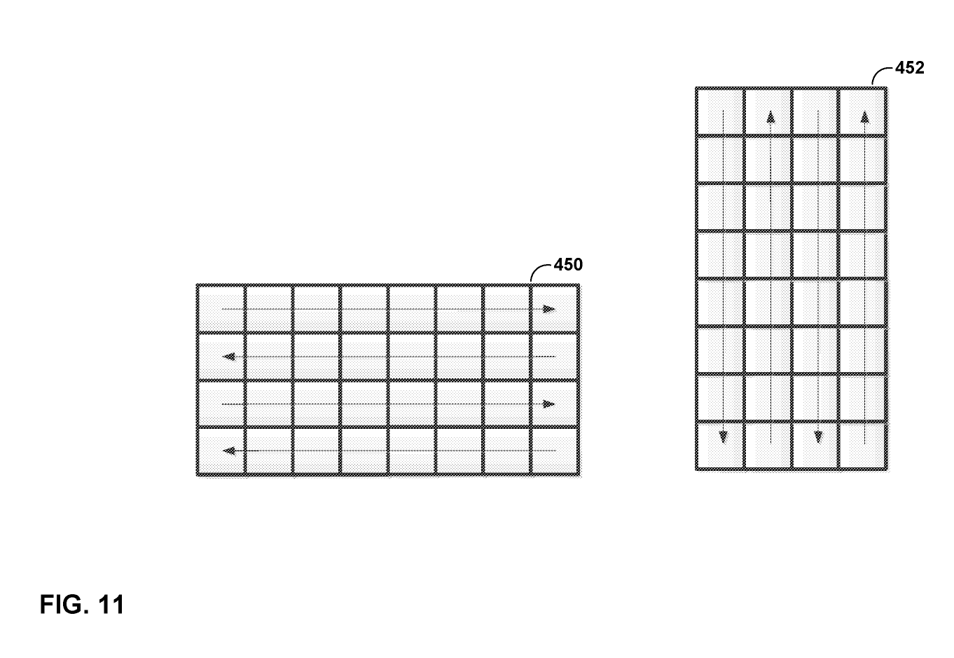

In another example of the disclosure, video encoder 200 and video decoder 300 may be configured to perform palette coding for a non-square coding block differently from the case when the coding block is square. For example, the scanning order used by video encoder 200 and video decoder 300 to code a block of video data may be dependent on the block shape. In one example, as shown in FIG. 11, video encoder 200 and video decoder 300 may be configured to scan samples inside a block row-by-row if the block width is larger than the block height, such as for block 450. Video encoder 200 and video decoder 300 may be configured to scan samples inside a block column-by-column if the block width is smaller than the block height, such as for block 452.

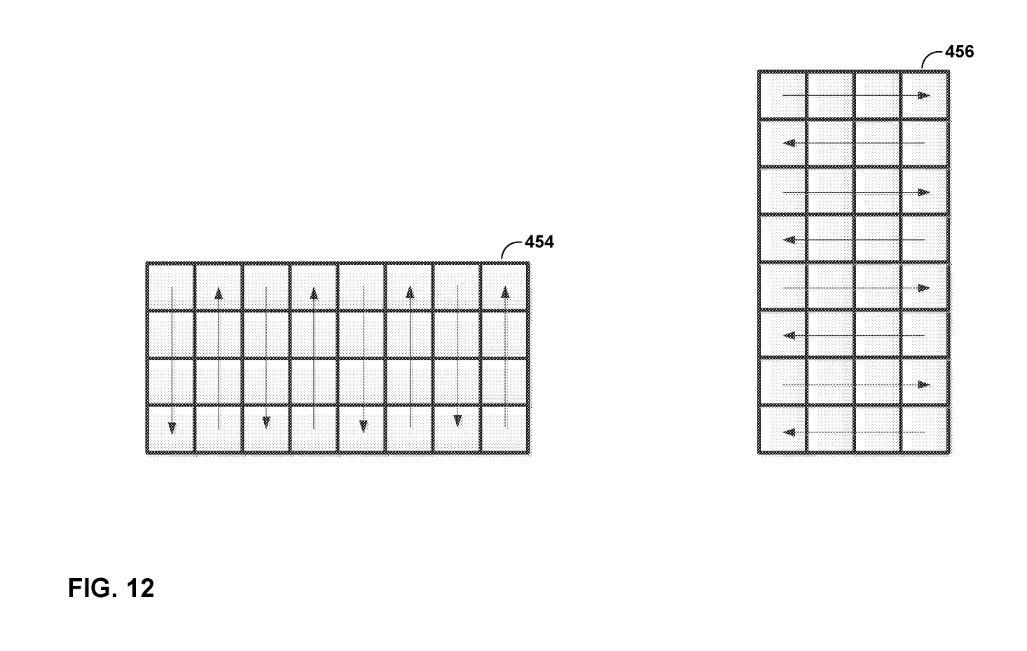

In another example, as shown in FIG. 12, video encoder 200 and video decoder 300 may be configured to scan samples inside a block column-by-column if the block width is larger than the block height, such as for block 454. Video encoder 200 and video decoder 300 may be configured to scan samples inside a block row-by-row if the block width is smaller than the block height, such as for block 456.

In another example of the disclosure, video encoder 200 and video decoder 300 may be configured to not apply filtering, such as an Adaptive Loop Filter (ALF) and/or a bilateral filter, to a block of video data coded using a palette coding mode. Such filters may smooth the colors in the block, and this may not be desirable for the more discrete-tone nature of screen content coded using a palette coding mode.

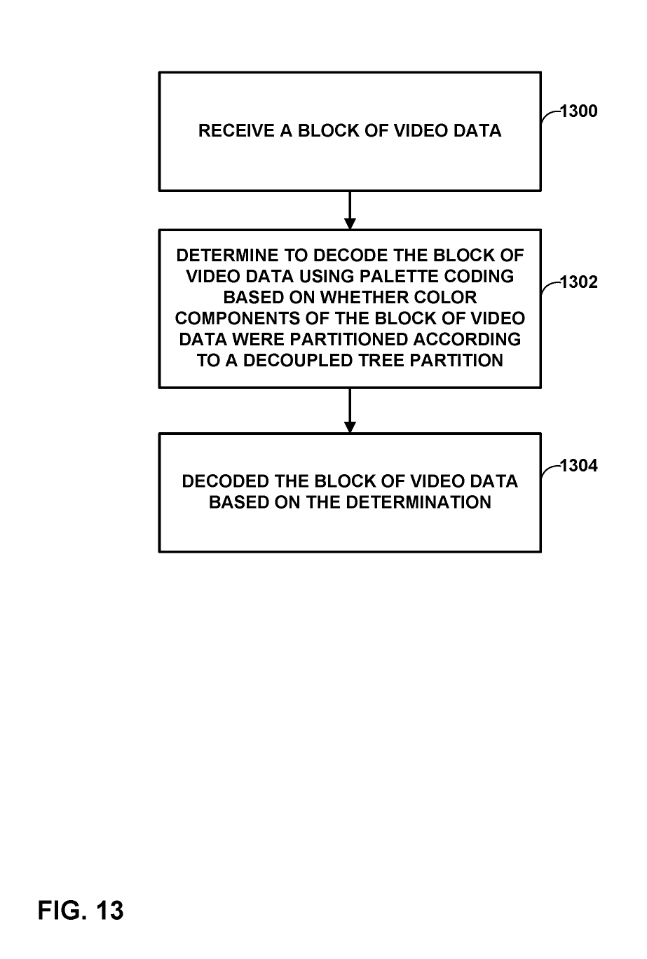

FIG. 13 is a flowchart showing an example decoding method of the disclosure. The techniques of FIG. 13 may be performed by one or more structural or software components of video decoder 300, including palette-based decoding unit 315.

In one example of the disclosure, video decoder 300 is configured to receive a block of video data (1300), determine to decode the block of video data using palette coding based on whether color components of the block of video data were partitioned according to a decoupled tree partition (1302), and decode the block of video data based on the determination (1304).

In one example, video decoder 300 is configured to partition the block of video data according to one of a quad-tree-binary-tree partition structure or a multi-type tree partition structure, wherein the quad-tree-binary-tree partition structure and the multi-type tree partition structure are decoupled tree partitions.

In another example, video decoder 300 is configured to determine that the block of video data is partitioned according to the decoupled tree partition, decode, based on the determination, a syntax element in a syntax structure that indicates whether palette coding is enabled, and decode the block of video data based on the syntax element. In one example, video decoder 300 is configured to decode the syntax element in one of a sequence parameter set, video parameter set, picture parameter set, or slice header.

In another example, to determine to decode the block of video data using palette coding, video decoder 300 is configured to determine not to decode the block of video data using palette coding if a picture, slice or coding tree unit containing the block of video data is partitioned according to the decoupled tree partition.

In another example, to determine to decode the block of video data using palette coding, video decoder 300 is configured to determine to decode one or more specific color components of the block of video data using palette coding if the block of video data is partitioned according to the decoupled tree partition.

In another example, to determine to decode the block of video data using palette coding, video decoder 300 is configured to determine to decode all color components of the block of video data using palette coding if the block of video data is partitioned according to the decoupled tree partition.

In another example, video decoder 300 is configured to decode a first syntax element that indicates whether palette coding is enabled for a first color component of the block of video data based on the value of a second syntax element that indicates whether palette coding is enabled for a second color component of the block of video data.

In another example, to determine to decode the block of video data using palette coding, video decoder 300 is configured to determine to decode a first color component of the block of video data using palette coding based on a mode index for a second color component of the block of video data.

In another example, video decoder 300 is configured to perform palette coding on the block of video data using one palette for a luma component of the block of video data and at least one other palette for the chroma components of the block of video data.

In another example, where the block of video data has a non-square shape, video decoder 300 is configured to decode the block of video data using palette coding according to a scan order of samples in the block, the scan order selected based on the non-square shape. In one example, the scan order is row-by-row if a width of the block of video data is larger than a height of the block of video data, and the scan order is column-by-column if a width of the block of video data is smaller than a height of the block of video data. In another example, the scan order is column-by-column if a width of the block of video data is larger than a height of the block of video data, and the scan order is row-by-row if a width of the block of video data is smaller than a height of the block of video data.

In another example, video decoder 300 is configured to disable one or more of bilateral filtering or adaptive loop filtering for the block of video data in the case that the block of video data is decoded using palette coding.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
receiving a block of video data;
determining to decode the block of video data using palette coding based on whether color components of the block of video data were partitioned according to a decoupled tree partition; and
decoding the block of video data based on the determination.

2. The method of claim 1, further comprising:
partitioning the block of video data according to one of a quad-tree-binary-tree partition structure or a multi-type tree partition structure, wherein the quad-tree-binary-tree partition structure and the multi-type tree partition structure are decoupled tree partitions.

3. The method of claim 1, further comprising:
determining that the block of video data is partitioned according to the decoupled tree partition;
decoding, based on the determination, a syntax element in a syntax structure that indicates whether palette coding is enabled; and
decoding the block of video data based on the syntax element.

4. The method of claim 3, further comprising:
decoding the syntax element in one of a sequence parameter set, video parameter set, picture parameter set, or slice header.

5. The method of claim 1, wherein determining to decode the block of video data using palette coding comprises:
determining not to decode the block of video data using palette coding if a picture, slice or coding tree unit containing the block of video data is partitioned according to the decoupled tree partition.

6. The method of claim 1, wherein determining to decode the block of video data using palette coding comprises:
determining to decode one or more specific color components of the block of video data using palette coding if the block of video data is partitioned according to the decoupled tree partition.

7. The method of claim 1, wherein determining to decode the block of video data using palette coding comprises:
determining to decode all color components of the block of video data using palette coding if the block of video data is partitioned according to the decoupled tree partition.

8. The method of claim 1, further comprising:
decoding a first syntax element that indicates whether palette coding is enabled for a first color component of the block of video data based on the value of a second syntax element that indicates whether palette coding is enabled for a second color component of the block of video data.

9. The method of claim 1, wherein determining whether to decode the block of video data using palette coding comprises:
determining to decode a first color component of the block of video data using palette coding based on a mode index for a second color component of the block of video data.

10. The method of claim 1, further comprising:
performing palette coding on the block of video data using one palette for a luma component of the block of video data and at least one other palette for the chroma components of the block of video data.

11. The method of claim 1, wherein the block of video data has a non-square shape, the method further comprising:
decoding the block of video data using palette coding according to a scan order of samples in the block, the scan order selected based on the non-square shape.

12. The method of claim 11, wherein the scan order is row-by-row if a width of the block of video data is larger than a height of the block of video data, and wherein the scan order is column-by-column if a width of the block of video data is smaller than a height of the block of video data.

13. The method of claim 11, wherein the scan order is column-by-column if a width of the block of video data is larger than a height of the block of video data, and wherein the scan order is row-by-row if a width of the block of video data is smaller than a height of the block of video data.

14. The method of claim 1, further comprising:
disabling one or more of bilateral filtering or adaptive loop filtering for the block of video data in the case that the block of video data is decoded using palette coding.

15. An apparatus configured to decode video data, the apparatus comprising:
a memory configured to store a block of video data; and
one or more processors in communication with the memory, the one or more processors configured to:
receive the block of video data;
determine to decode the block of video data using palette coding based on whether color components of the block of video data were partitioned according to a decoupled tree partition; and
decode the block of video data based on the determination.

16. The apparatus of claim 15, wherein the one or more processors are further configured to:
partition the block of video data according to one of a quad-tree-binary-tree partition structure or a multi-type tree partition structure, wherein the quad-tree-binary-tree partition structure and the multi-type tree partition structure are decoupled tree partitions.

17. The apparatus of claim 15, wherein the one or more processors are further configured to:
determine that the block of video data is partitioned according to the decoupled tree partition;
decode, based on the determination, a syntax element in a syntax structure that indicates whether palette coding is enabled; and
decode the block of video data based on the syntax element.

18. The apparatus of claim 17, wherein the one or more processors are further configured to:
decode the syntax element in one of a sequence parameter set, video parameter set, picture parameter set, or slice header.

19. The apparatus of claim 15, wherein to determine to decode the block of video data using palette coding, the one or more processors are further configured to:
determine not to decode the block of video data using palette coding if a picture, slice or coding tree unit containing the block of video data is partitioned according to the decoupled tree partition.

20. The apparatus of claim 15, wherein to determine to decode the block of video data using palette coding, the one or more processors are further configured to:
determine to decode one or more specific color components of the block of video data using palette coding if the block of video data is partitioned according to the decoupled tree partition.

21. The apparatus of claim 15, wherein to determine to decode the block of video data using palette coding, the one or more processors are further configured to:
determine to decode all color components of the block of video data using palette coding if the block of video data is partitioned according to the decoupled tree partition.

22. The apparatus of claim 15, wherein the one or more processors are further configured to:
decode a first syntax element that indicates whether palette coding is enabled for a first color component of the block of video data based on the value of a second syntax element that indicates whether palette coding is enabled for a second color component of the block of video data.

23. The apparatus of claim 15, wherein to determine to decode the block of video data using palette coding, the one or more processors are further configured to:
determine to decode a first color component of the block of video data using palette coding based on a mode index for a second color component of the block of video data.

24. The apparatus of claim 15, wherein the one or more processors are further configured to:
perform palette coding on the block of video data using one palette for a luma component of the block of video data and at least one other palette for the chroma components of the block of video data.

25. The apparatus of claim 15, wherein the block of video data has a non-square shape, and wherein the one or more processors are further configured to:
decode the block of video data using palette coding according to a scan order of samples in the block, the scan order selected based on the non-square shape.

26. The apparatus of claim 25, wherein the scan order is row-by-row if a width of the block of video data is larger than a height of the block of video data, and wherein the scan order is column-by-column if a width of the block of video data is smaller than a height of the block of video data.

27. The apparatus of claim 25, wherein the scan order is column-by-column if a width of the block of video data is larger than a height of the block of video data, and wherein the scan order is row-by-row if a width of the block of video data is smaller than a height of the block of video data.

28. The apparatus of claim 15, wherein the one or more processors are further configured to:
disable one or more of bilateral filtering or adaptive loop filtering for the block of video data in the case that the block of video data is decoded using palette coding.

29. An apparatus configured to decode video data, the apparatus comprising:
means for receiving a block of video data;
means for determining to decode the block of video data using palette coding based on whether color components of the block of video data were partitioned according to a decoupled tree partition; and
means for decoding the block of video data based on the determination.

30. A non-transitory computer-readable storage medium storing instructions that, when executed, cause one or more processors configured to decode video data to:
receive block of video data;
determine to decode the block of video data using palette coding based on whether color components of the block of video data were partitioned according to a decoupled tree partition; and
decode the block of video data based on the determination.
